(19) United States
(12) Patent Application Publication
(10) Pub. No.: US 2009/0217716 A1
(43) Pub. Date: Sep. 3, 2009

(54) Security Opening Mechanism

(76) Inventors: Pedro Andres Diaz Aranda, Madrid (ES); Luis Sanfiz Carvajal, Madrid (ES); Jose Manuel Nobre Garci, Madrid (ES)

Correspondence Address: LADAS & PARRY LLP, 26 WEST 61ST STREET, NEW YORK, NY, 10023, US

(21) Appl. No.: 11/921,371

(22) PCT Filed: Jun. 1, 2005
(86) PCT No.: PCT/ES2005/070077

§ 371 Date: Feb. 10, 2009

(51) Int. Cl. E05B 47/00

(52) U.S. Cl. 70/266

(57) ABSTRACT

The present invention relates to a tamper proof security system comprising an opening mechanism (12) which can be incorporated to an anti-theft merchandise protection means (12) used in commerce, and an energy supply means which generates a temperature increase in a thermal expansion means (18) included in the anti-theft protector (11) once the latter is brought towards the energy source, such temperature increase causing a travel of the expansion means (18), shifting a locking element (17) comprised in the opening mechanism (12) to cause the opening of the anti-theft protector (11), then being able to remove from inside the mentioned protector (11) the object contained therein.

### OBJECT OF THE INVENTION

The present invention generally relates to an opening mechanism for a security device, the security device being intended for being assembled on or containing an object in a display in a shop.

The present invention more specifically relates to an opening mechanism for a security device which forms a lock coupling, in a locked position, in said security device, the opening device usually being kept in a locked position so that it can be actuated by generating a thermal gradient on said opening mechanism, taking it from the locked position to an open or unlocked position.

### STATE OF THE ART

Anti-theft containers are currently known which are used to store objects and which in turn allow a potential buyer to examine the object contained in said container. The anti-theft container cannot be opened by the public examining the merchandise because said container comprises a magnetically operated opening mechanism which locks the opening of the mentioned container.

The opening mechanism comprises a guided metallic pin which is required in the engaging position, namely in a locked anti-theft container, due to the action of a spring. The opening action is carried out by means of a magnetizing device outside the container which is usually located at the shop cash register.

The magnetizing device is a strong permanent magnet which extracts the guided metal pin due to the action of magnetic attraction, overcoming the antagonist effort of the mentioned spring, releasing it from a first cover of the container which can be slid in the opening direction of the container, until sufficiently uncovering the rest of the container so as to allow the extraction of the object contained inside the mentioned anti-theft container and being able to be given to the customer who has requested it.

This type of security system has a series of drawbacks, such as the fact that the permanent magnet of the shop can be replaced by a strong permanent magnet which is carried by a potential buyer; accordingly the combined security system previously described does not prevent merchandise displayed on a shelf of a shop from being taken out of the shop without permission.

One way to prevent the permanent magnet of the shop from being replaced is to install in the plastic container an opening and locking mechanism comprising a spring which exerts a resistant force having a magnitude that requires a very strong magnet, which translates into the use of a very large, cumbersome and heavy substitute magnet that would have to be carried by the customer visiting the shop. Said substitute magnet would therefore be cumbersome for the customer to carry.

It is therefore necessary to develop a security system for merchandise on display in a shop which is secure and reliable, i.e. eliminates the possibility of substituting any of the devices forming the security systems.

### CHARACTERIZATION OF THE INVENTION

The present invention aims to resolve or reduce one or more of the drawbacks set forth above by means of a security opening mechanism as claimed in claim 1. Embodiments of the invention are set out in the dependent claims.

An object of the invention is to form an opening mechanism that can be opened by providing energy which is transformed into a temperature increase.

Another object of the invention is to provide a secure and reliable security system.

Yet another object of the invention is to provide a simple security system with low manufacturing costs, i.e. it is an economical and effective security system.

Another object of the invention is to apply the opening mechanism in a wide variety of reusable security devices for protecting objects on display, such as clothes, cassettes, compact discs and the like which, due to their high price and small size, must be protected from the fraudulent or unauthorized taking from a display shelf of a shop to a point outside the shop.

Yet another object of the invention is to reduce surveillance provided by other types of security systems and to reduce the damage brought about by theft.

Yet another object of the invention is to provide a security system which is easily manageable and requires little time to be opened by the employees of the establishment.

### BRIEF DESCRIPTION OF THE DRAWINGS

A more detailed explanation of the invention is provided in the following description based on the attached figures in which:

FIG. 1 shows a plan view in cross section along the X-X, X′-X′ axes of a security opening mechanism in the locked or closed position according to the invention, and

FIG. 2 shows a plan view in cross section along the Y-Y, Y′-Y′ axes of a security opening mechanism in the unlocked or open position according to the invention.

### DESCRIPTION OF THE INVENTION

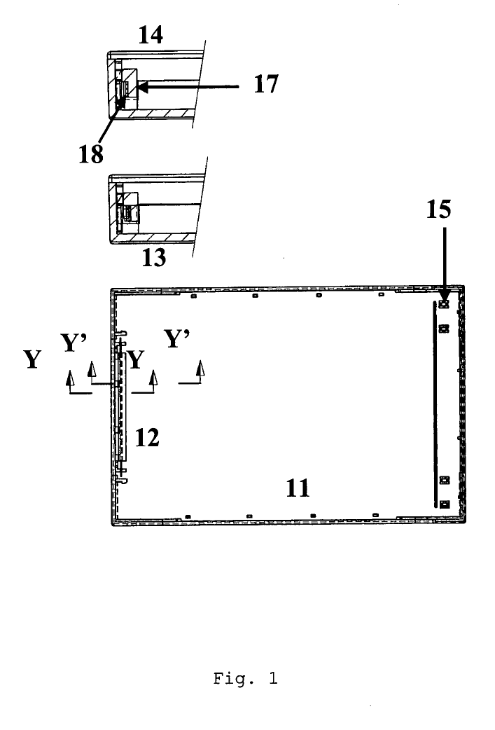

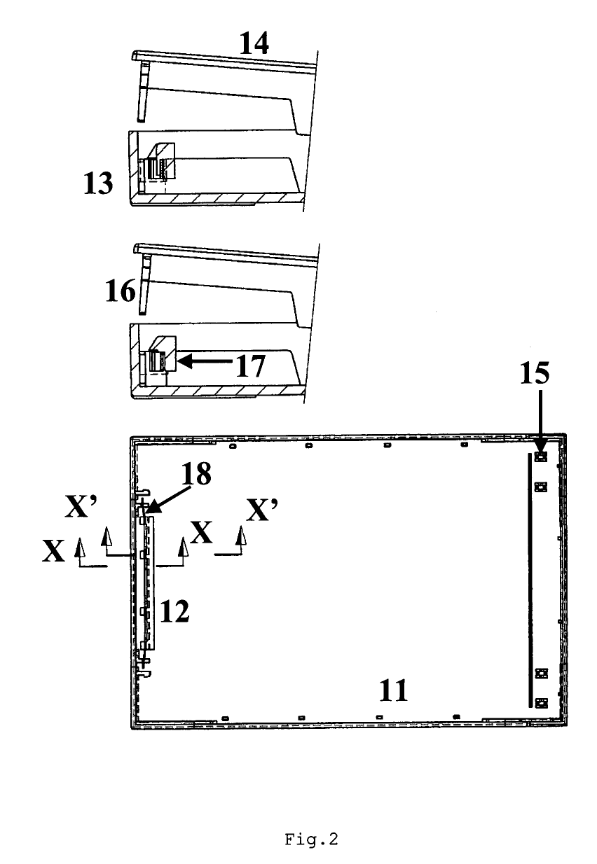

A tamper proof security system is illustrated below in reference to FIGS. 1 and 2, comprising an anti-theft protection means 11 in turn including a security opening mechanism 12 to prevent the extraction of an object contained (not shown) in the mentioned anti-theft protector 11, and an energy supply means (not shown) located close to a cash register of the shop.

The protector 11 comprises a case 13 forming a cavity for housing the object to be protected and a cover 14 which is interconnected to the case by hinge means 15.

The opening mechanism 12 is usually located on the side opposite to the hinge 15, on the inner side of the cavity of the case 13, and it is facing an interlocking element 16, shown in FIG. 2, projecting from the cover 14 on the distal end of the hinge 15 towards the cavity of the case 13 of the protector 11.

Going back to FIG. 1, the protector 11 is locked, i.e. the interlocking element 16 is locked by a locking element 17, namely a latch, included in the opening mechanism 12. Therefore the cover of the protector 11 cannot be opened because the latch 17 engages the interlocking element 16 of the cover 14, preventing the mentioned cover 14 from sliding to the open position shown in FIG. 2.

When the energy source is turned on and the protector 11 is close to said source, a temperature increase occurs in a thermal expansion means 18 included inside the opening mechanism 12, causing a predetermined travel of the expansion means 18 which shifts the latch 17 such that it goes from the locked position to an unlocked position, causing the protector 11 to open and then being able to remove from the cavity of the case 13 of the protector 11 the object contained therein.

The energy source generates an electromagnetic field such that when the opening mechanism 12 is introduced in the electromagnetic field coverage area the electromagnetic waves of the mentioned field generate heat in the expansion means 18 such that one of its longitudinal dimensions experiences a magnitude increase.

The energy source comprises a winding through which an electric current flows, generating the electromagnetic field, and when the part of the display protector 11 in which the expanding means 18, for example a bimetallic strip, is located is introduced in said electromagnetic field, it begins to heat up, this effect not occurring in the material which the display protector 11 is made of.

It must be noted that the energy transmitted by the electromagnetic field to the bimetallic strip 18 causes a temperature increase therein which is not transmitted to the case 13 or to the cover 14, or to any other element of the protector 11; the protector 11 is therefore reusable.

It must be noted that no type of resistance is used as a heat source. Nor does any direct contact occur between the source and the expansion means 18. The heat is generated due to the movement of the electrons in the bimetallic strip 18.

Obviously, to generate sufficient travel of the latch 17 so as to allow the opening of the cover 14 of the protector 11, the bimetallic strip 18 must remain in the electromagnetic field for a predetermined time period such that it assures generating a temperature gradient that exceeds a predetermined threshold level.

The opening mechanism 12 comprises a seat within which the expansion means 18 can be inserted, the latter having a high thermal expansion and deformation coefficient so that the expansion means 18 are shifted with respect to the initial position when the opening mechanism 12 is kept within the electromagnetic field for a predetermined time period.

The mentioned expansion means 18 can be given different shapes, such as a rectangular strip shape, a disc shape, a tab shape or the like. Depending on the shape of the expansion means 18, the seat will be given a suitable shape so that the travel of the expansion means 18 unlocks the latch 17 of the cover 14 of the protector 11.

It must be noted that the direction of the travel will be oriented such that it releases the latch 17, for example the travel is carried out towards the inside of the case 13 but in other arrangements of the opening mechanism 12 it would be possible for the expansion means 18 to travel in other directions of the cavity of the case 13, shown in FIG. 2.

Heating of the bimetallic strip 18 is very fast, therefore the time necessary for the action of opening the protector 11 to occur is very short; therefore the consumption of electrical energy is also low.

The energy source can be an electromagnetic induction source, for example, or any other type of energy source that is able to cause a temperature increase on the bimetallic strip 19 without any direct contact between the energy source and the bimetallic strip 18, maintaining the physical integrity of the display protector 11.

The consequence of the temperature increase in the bimetallic strip 18 causes an increase in the distance between ends, usually the longitudinal dimension, of the mentioned bimetallic strip 18 such that it becomes deformed, causing a predetermined deflection which is a function of the different thermal expansion coefficients of the components of the bimetallic strip 18. Therefore, the expansion is transformed into a travel of the bimetallic strip 18 causing the latch 17 to travel, and accordingly the cover 14 is no longer retained by the opening mechanism 12, the cover 14 being able to be slid off the rest of the case 13 of the protector 11 in the opening direction thereof until sufficiently uncovering it to allow the extraction of the object contained inside the anti-theft protector 11, and being able to be given to the customer who has requested it.

The case 13 obviously protects, or comprises or locks merchandise such as rope, cassettes, compact discs and the like inside it.

The display protector 11 is made of a preferably transparent plastic material by injection and it is given a predetermined thickness which assures a predetermined degree of mechanical strength against direct impacts or attempts to open it by force.

The anti-theft protector 11 can be provided with one or more sensors (not shown) to activate an electric alarm system when the protector is taken out of the shop.

The opening mechanism 12 can be adapted to other types of anti-theft display protectors such as bands to be arranged on bottle necks, button-type anti-theft display protectors for clothing articles or the like.

The embodiments and examples set forth in this specification are presented as the best explanation of the present invention and its practical application, and to thus allow the persons skilled in the art to put the invention into practice and use it. Nevertheless, those persons skilled in the art will recognize that the foregoing description and examples have been presented for only illustrating the invention and as an example. As the description is given, it is not intended to be thorough or to limit the invention to the precise embodiment described. Many modifications and changes are possible in light of the preceding teaching without departing from the content and scope of the following claims.

1. A security opening mechanism for protecting objects on display in a shop, characterized in that the security opening mechanism (12) comprises a thermal expansion means (18) having a predetermined thermal expansion and deformation coefficient.

2. A mechanism according to claim 1, wherein the thermal expansion means (18) are a bimetallic strip anchored in a seat of the security opening mechanism (12).

3. A mechanism according to claim 2, wherein the bimetallic strip (18) becomes deformed, due to generating a temperature increase in said bimetallic strip (18), in a predetermined direction of a dimension of the mentioned bimetallic strip (18), causing a travel of a locking element (17) included in the mentioned security opening mechanism (11), unlocking an interlocking element (16).

4. A mechanism according to claim 3, wherein the security opening mechanism (12) can be included in an anti-theft protection means (11).

5. A mechanism according to claim 4, which can be used to be attached to objects on display, providing a function of a button, a band, a container or the like, to secure the mentioned object.

6. An energy source generating a temperature increase in a security opening mechanism (12) according to claim 1, wherein the energy source generates an electromagnetic field of a predetermined value heating a thermal expansion means (18) when said security opening mechanism (12) remains within the magnetic field for a predetermined time period.

7. An energy source according to claim 6, wherein the energy source is an electromagnetic induction source.

8. An energy source according to claim 7, wherein the energy source generates heat in the thermal expansion means (18) with no direct contact between them.

9. A security system comprising an energy source according to claim 6, providing a temperature increase in a thermal expansion means (18) according to claim 1 so as to shift them when the thermal expansion means (18) are within the electromagnetic field generated by the mentioned energy source.

10. An anti-theft display protector so that said object can be examined by the public visiting the shop, including the security opening mechanism (12) according to claim 1.

11. An anti-theft protector (11) according to claim 10 made of a plastic material.

12. An anti-theft protector (11) according to claim 11 made of a transparent plastic material.

13. An anti-theft protector (11) according to claim 12 made of a plastic material which is injection molded and provided with a thickness having a predetermined value assuring a predetermined degree of mechanical strength against direct impacts and attempts to force it open.
